(19) United States
(12) Patent Application Publication
(10) Pub. No.: US 2025/0260595 A1
(43) Pub. Date: Aug. 14, 2025

(54) DATA COMMUNICATION DEVICE AND DATA COMMUNICATION SYSTEM

(71) Applicant: DENSO CORPORATION, Kariya-city (JP)

(72) Inventors: TOSHIYA TANAKA, Kariya-city (JP); HONGLIANG DENG, Kariya-city (JP)

(21) Appl. No.: 19/013,695

(22) Filed: Jan. 8, 2025

(30) Foreign Application Priority Data
Feb. 13, 2024 (JP) 2024-019470

(51) Int. Cl. H04L 12/40; H04L 12/12

(52) U.S. Cl. CPC H04L 12/40039; H04L 12/12; H04L 2012/40273

(57) ABSTRACT

A data communication device is connected to an Ethernet, and includes a transmission and reception unit in which at least one of a data transmission side and a data reception side conforms to a TC 10 specification. The data transmission and reception unit executes a forced sleep process to force the data transmission and reception unit to be in a sleep state after a predetermined time has elapsed since invalidating a transmission function of the data transmission and reception unit. The data transmission and reception unit validates the transmission function of the data transmission and reception unit after completing the forced sleep process.

### CROSS REFERENCE TO RELATED APPLICATION

The present application claims the benefit of priority from Japanese Patent Application No. 2024-019470 filed on Feb. 13, 2024. The entire disclosure of the above application is incorporated herein by reference.

### TECHNICAL FIELD

The present disclosure relates to a data communication device and a data communication system.

### BACKGROUND ART

A vehicle is equipped with a plurality of electronic control units (hereinafter referred to as ECUs), and the ECUs are connected to each other via a communication bus so as to be able to communicate data with each other. For example, a conceivable technique teaches a configuration in which a gateway and multiple ECUs are connected via a communication bus to enable data communication, and the gateway controls the multiple ECUs to be in a sleep mode when a sleep-prohibition request is not transmitted from the outside, controls the multiple ECUs not to be in the sleep mode when the sleep-prohibition request is transmitted from the outside, and controls the multiple ECUs to be in the sleep mode when certain conditions are met even if the sleep-prohibition request is transmitted from the outside.

### SUMMARY OF INVENTION

According to an example, a data communication device is connected to an Ethernet, and may include a transmission and reception unit in which at least one of a data transmission side and a data reception side conforms to a TC 10 specification. The data transmission and reception unit executes a forced sleep process to force the data transmission and reception unit to be in a sleep state after a predetermined time has elapsed since invalidating a transmission function of the data transmission and reception unit. The data transmission and reception unit validates the transmission function of the data transmission and reception unit after completing the forced sleep process.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram illustrating an overall configuration of a first embodiment;

FIG. 2 is a timing chart;

FIG. 3 is a timing chart;

FIG. 4 is a flow chart;

FIG. 5 is a timing chart;

FIG. 6 is a flowchart showing a second embodiment;

FIG. 7 is a timing chart;

FIG. 8 is a flowchart showing a third embodiment;

FIG. 9 is a timing chart;

FIG. 10 is a flowchart showing a fourth embodiment;

FIG. 11 is a timing chart;

FIG. 12 is a flowchart showing a fifth embodiment; and

FIG. 13 is a timing chart.

### DETAILED DESCRIPTION

Ethernet (registered trademark) is widely used as a communication bus, and the standardization of the physical layer and the data link layer implemented in the data transmission and reception units of Ethernet is defined by the TC 10 specifications of the OPEN Alliance. The TC 10 specifications define a handshake method for setting the sleep mode by transmitting and receiving a low power sleep (i.e., LPS) signal with a link partner (i.e., LP) that is a communication partner. In the event of an anomaly such as a broken wire, or in a combination with a communication partner that does not comply with the TC 10 specifications, it is not possible to transmit or receive a LPS signal, and it is necessary to execute the forced sleep process for setting the subject ECU to be in the sleep mode in order to put the ECU into a sleep mode. In such a case, the handshake method cannot be adopted, and the data transmission and reception unit must be immediately forced to set into the sleep mode by means of register settings or the like.

However, when the forced sleep process is performed, the following difficulties arise. In the 100 BASE-T1, since there is no difference in the standard between the waveforms of the wake-up signal, the link training signal, and the idle signal, if the transmission waveform remains on the Ethernet for a certain period of time due to reflection after the ECU stops transmitting a signal, the remaining signal from the remaining transmission waveform may be mistakenly detected as a wake-up signal, so that the state returns from the sleep state to the wake-up state. In the 1000 BASE-T1, when the link is down, the wake-up signal is transmitted continuously at a cycle of 40 ms in accordance with the TC 10 specifications. In this case, if the transmission waveform remains on the Ethernet for a certain period of time due to reflection after the signal transmission from the subject ECU has stopped, the remaining signal caused by the remaining transmission waveform may be mistakenly detected as a wake-up signal, so that the state returns from the sleep state to the wake-up state. That is, although the manner in which signals are transmitted differs between the 100 BASE-T1 and the 1000 BASE-T1, there is a difficulty in both the 100 BASE-T1 and the 1000 BASE-T1 that a remaining signal due to the transmission waveform may be mistakenly detected as a wake-up signal, so that the state returns from a sleep state to a wake-up state.

The present disclosure has been made in consideration of the above circumstances, and an object of the present disclosure is to provide a data communication device and a data communication system that can properly perform the forced sleep process.

According to a data communication device described in feature 1, at least one of a data transmission side and a data reception side is configured with a data transmission and reception unit conforming to the TC 10 specifications and is connected to the Ethernet. A forced sleep process is performed to forcibly put the data transmission and reception unit into a sleep mode after a predetermined time has elapsed since invalidating the transmission function of the data transmission and reception unit, and the transmission function of the data transmission and reception unit is validated after completing the forced sleep process.

By performing the forced sleep process after a predetermined time has elapsed since invalidating the transmission function of the data transmission and reception unit, the forced sleep process can be performed in a state where no transmission waveform caused by the reflection remains on the Ethernet. Thus, it is possible to prevent a situation in which a remaining signal due to a remaining transmission waveform is mistakenly detected as a wake-up signal and the state returns from a sleep state to a wake-up state, so that the forced sleep process can be performed properly.

According to a data communication device described in feature 2, at least one of a data transmission side and a data reception side is configured with a data transmission and reception unit conforming to the TC 10 specifications and is connected to the Ethernet. The reception function of the data transmission and reception unit is invalidated, and then a forced sleep process is performed to forcibly put the data transmission and reception unit into a sleep mode.

By performing the forced sleep process after invalidating the reception function of the data transmission and reception unit, even if the transmission waveform remains on the Ethernet for a certain period of time due to reflection after signal transmission has been stopped, the forced sleep process can be performed in a state where the reception of the remaining signal due to the remaining transmission waveform is invalidated. Thus, it is possible to prevent a situation in which a remaining signal due to a remaining transmission waveform is mistakenly detected as a wake-up signal and the state returns from a sleep state to a wake-up state, so that the forced sleep process can be performed properly.

According to a data communication device described in feature 4, at least one of a data transmission side and a data reception side is configured with a data transmission and reception unit conforming to the TC 10 specifications and is connected to the Ethernet. A wake-up signal detection function of the data transmission and reception unit is invalidated, and then a forced sleep process is performed to forcibly put the data transmission and reception unit to a sleep mode.

By performing the forced sleep process after invalidating the wake-up signal detection function of the data transmission and reception unit, even if the transmission waveform remains on the Ethernet for a certain period of time due to reflection after signal transmission has been stopped, and the remaining signal caused by the remaining transmission waveform is received, the forced sleep process can be performed in a state where the detection of the wake-up signal is invalidated. Thus, it is possible to prevent a situation in which a remaining signal due to a remaining transmission waveform is mistakenly detected as a wake-up signal and the state returns from a sleep state to a wake-up state, so that the forced sleep process can be performed properly.

Hereinafter, multiple embodiments will be described with reference to the drawings. In the following description, descriptions of equivalent configurations as the ones described in the preceding embodiment may be omitted for simplification.

### First Embodiment

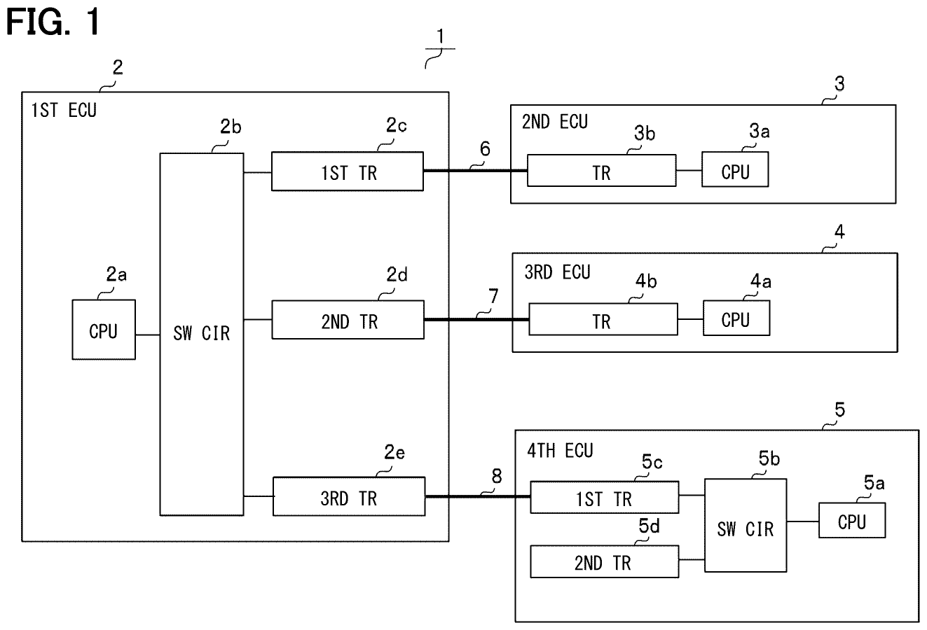

A first embodiment will be described with reference to FIG. 1 to FIG. 5.

As shown in FIG. 1, the data communication system 1 includes a first ECU 2 and second to fourth ECUs 3 to 5. The first ECU 2 and the second ECU 3 are connected to each other via Ethernet 6 so as to be able to communicate data with each other. The first ECU 2 and the third ECU 4 are connected to each other via Ethernet 7 so as to be able to communicate data with each other. The first ECU 2 and the fourth ECU 5 are connected to each other via Ethernet 8 so as to be able to communicate data with each other. The first ECU 2 functions as a gateway that controls a plurality of ECUs including the three ECUs 3 to 5. Although a configuration in which three ECUs 3 to 5 are connected to the first ECU 2 is illustrated, the number of ECUs connected to the first ECU 2 is not limited to three.

The first ECU 2 includes a CPU 2a, a switch circuit 2b, and a first transceiver 2c to a third transceiver 2e. The CPU 2a executes a computer program stored in a non-transitory tangible storage medium, and controls the operation of the first ECU 2 by executing control through software processing. The operation of the first ECU 2 may be controlled by combining control by software processing and control by hardware processing using a dedicated electronic circuit. The switch circuit 2b switches communication control among the first transceiver 2c to the third transceiver 2e in response to a data communication request from the CPU 2a, for example. For example, when the switch circuit 2b receives a data communication request from the CPU 2a to communicate with the second ECU 3, the switch circuit 2b causes the first transceiver 2c to control the communication. For example, when the switch circuit 2b receives a data communication request from the CPU 2a to communicate with the third ECU 4, the switch circuit 2b causes the second transceiver 2d to perform the communication control. For example, when the switch circuit 2b receives a data communication request from the CPU 2a to communicate with the fourth ECU 5, the switch circuit 2b causes the third transceiver 2e to perform the communication control.

The second ECU 3 includes a CPU 3a and a transceiver 3b. The CPU 3a executes a computer program stored in a non-transitory tangible storage medium, and controls the operation of the second ECU 3 by executing control through software processing. The operation of the second ECU 3 may be controlled by combining control by software processing and control by hardware processing using a dedicated electronic circuit.

The third ECU 4 includes a CPU 4a and a transceiver 4b. The CPU 4a executes a computer program stored in a non-transitory tangible storage medium, and controls the operation of the third ECU 4 by executing control through software processing. The operation of the third ECU 4 may be controlled by combining control by software processing and control by hardware processing using a dedicated electronic circuit.

The fourth ECU 5 includes a CPU 5a, a switch circuit 5b, and a first transceiver 5c to a second transceiver 5d. The CPU 5a executes a computer program stored in a non-transitory tangible storage medium, and controls the operation of the fourth ECU 5 by executing control through software processing. The operation of the fourth ECU 5 may be controlled by combining control by software processing and control by hardware processing using a dedicated electronic circuit. The switch circuit 5b switches communication control among the first transceiver 5c to the second transceiver 5d in response to a data communication request from the CPU 5a, for example.

The first transceiver 2c to the third transceiver 2e of the first ECU 2, the transceiver 3b of the second ECU 3, the transceiver 4b of the third ECU 4, and the first transceiver 5c and the second transceiver 5d of the fourth ECU 5 each comply with the TC 10 specifications of the OPEN Alliance, and the TC 10 specifications define a sleep function and a wake-up function. Also, a transceiver is a device for implementing the functions of the Physical Layer of the OSI reference model.

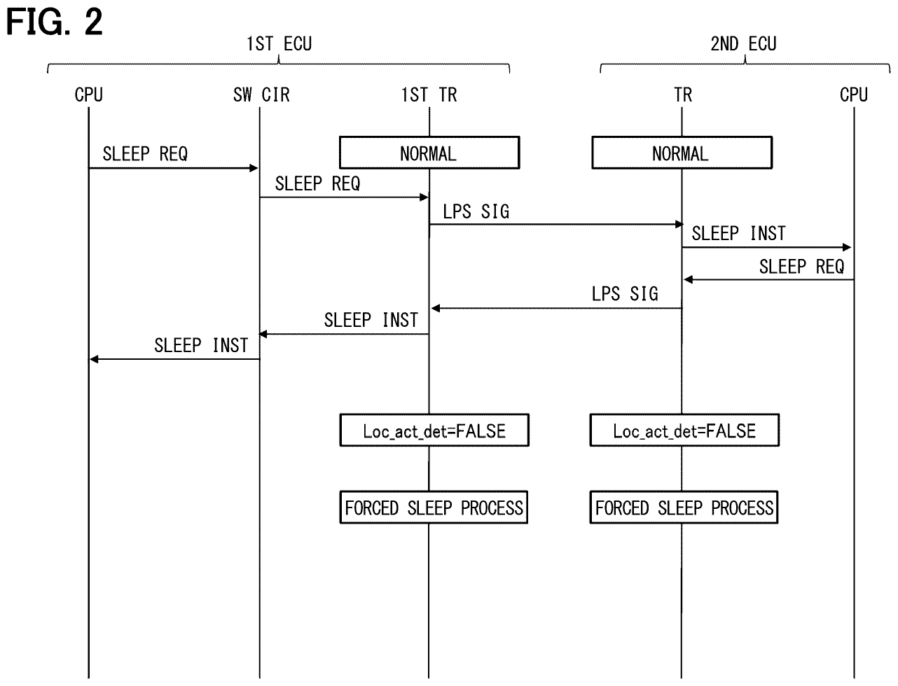

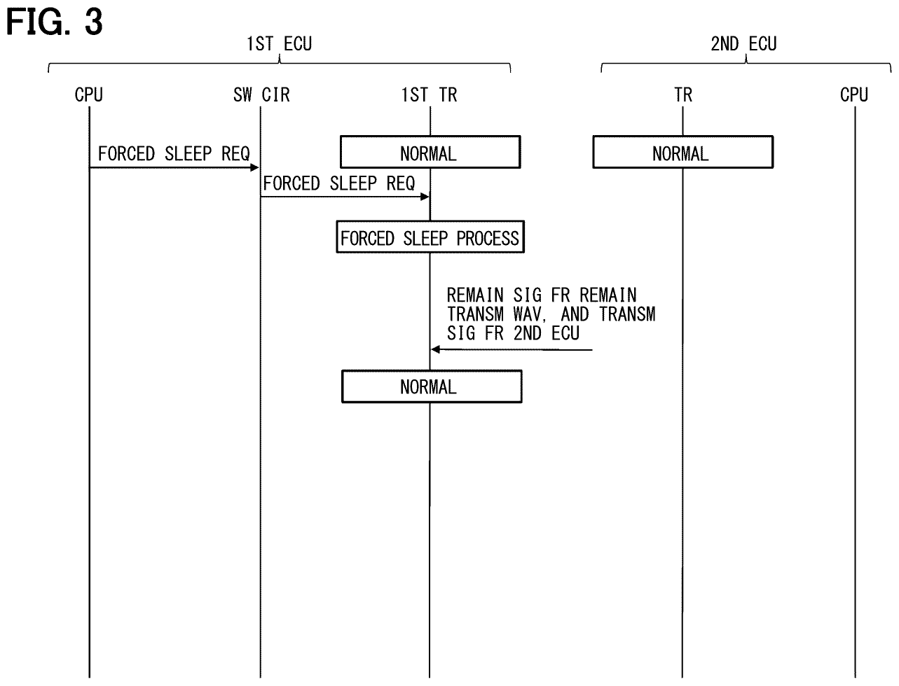

The forced sleep state may be entered by a handshake of the LPS signal or by a forced instruction. Each of these cases will be described below with reference to FIG. 2 and FIG. 3. Here, data communication between the first ECU 2 and the second ECU 3 is illustrated, and a case is illustrated in which the first ECU 2 operates as a master ECU and the second ECU 3 operates as a slave ECU. The first ECU 2 corresponds to a data communication device, and the first transceiver 2c corresponds to a data transmission and reception unit.

### (1) Case where Transitioning to a Forced Sleep Mode by LPS Signal Handshake (see FIG. 2)

In the first ECU 2, when the first transceiver 2c is in the normal state, the CPU 2a outputs a sleep request to the first transceiver 2c via the switch circuit 2b. The normal state is equivalent to the wake-up state. When a sleep request is input from the CPU 2a via the switch circuit 2b, the first transceiver 2c transmits an LPS signal to the second ECU 3.

In the second ECU 3, when the transceiver 3b receives the LPS signal transmitted from the first ECU 2, the second ECU 3 outputs a sleep instruction to the CPU 3a. When a sleep instruction is input from the transceiver 3b, the CPU 3a outputs a sleep request to the transceiver 3b. When the transceiver 3b receives a sleep request from the CPU 3a, the transceiver 3 b transmits an LPS signal to the second ECU 3. The transceiver 3b detects the bus state of the Ethernet 6, and if both the transceiver 3b and the first transceiver 2c are in the silent state (i.e., “Loc_act_det”=“FALSE”), then it is possible to transition to the forced sleep mode, and therefore performs the forced sleep process.

In the first ECU 2, when the first transceiver 2c receives the LPS signal transmitted from the first ECU 2, the first transceiver 2c outputs a sleep instruction to the CPU 2a via the switch circuit 2b. The first transceiver 2c detects the bus state of the Ethernet 6, and when it is determined that both the first transceiver 2c and the transceiver 3b are in the silent state (i.e., “Loc_act_det”=“FALSE”), then it is possible to transition to the forced sleep mode, and therefore the first transceiver 2c performs the forced sleep process.

### (2) Case where Transitioning to Forced Sleep Mode by a Forced Instruction (see FIG. 3)

In the first ECU 2, when the first transceiver 2c is in the normal state, the CPU 2a outputs a forced sleep request to the first transceiver 2c via the switch circuit 2b. When the first transceiver 2c receives the forced sleep request from the CPU 2a, the first transceiver 2c executes the forced sleep process. In this case, the bus state of Ethernet 6 is not detected by handshaking the LPS signal, and therefore, when a transmission waveform remains on the Ethernet 6 for a certain period of time after the forced sleep process is completed, the remained signal due to the remaining transmission waveform may be erroneously detected as a wake-up signal. In addition, the signal transmitted from the first ECU 2 may be erroneously detected as a wake-up signal. As a result, the state may return from a sleep state to a wake-up state.

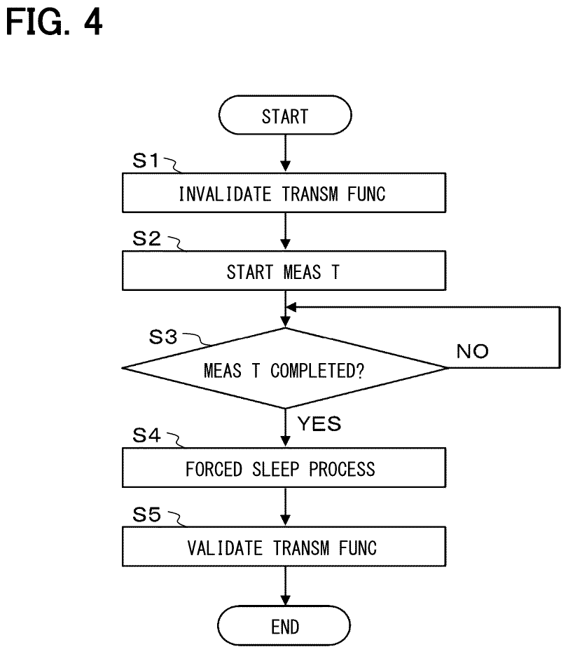

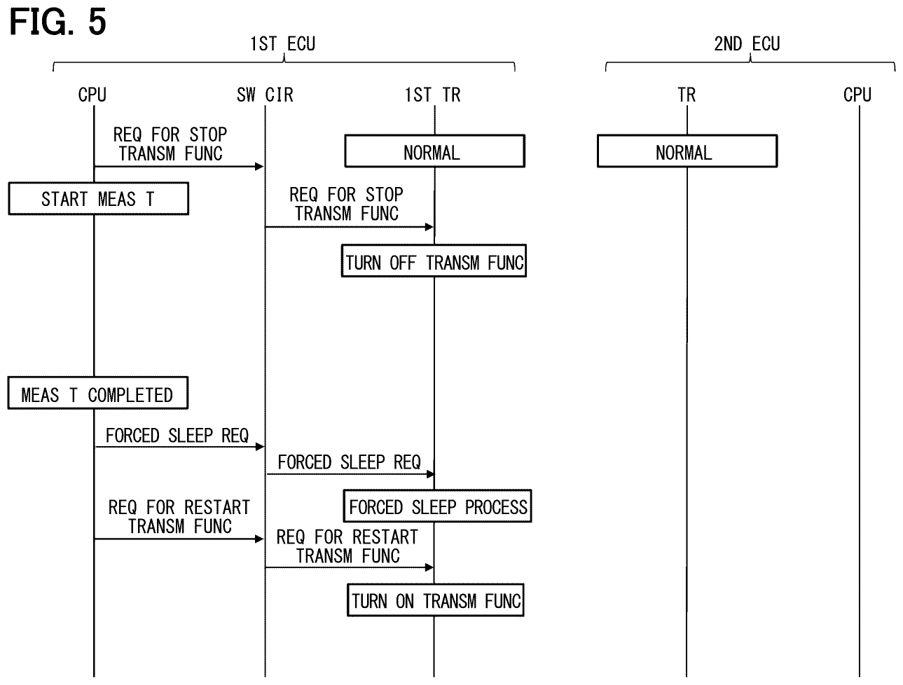

In this regard, in this embodiment, the following process is performed to prevent the state from returning from the sleep state to the wake-up state. Next, the process of the above configuration will be described with reference to FIGS. 4 to 5.

In the first ECU 2, when the first transceiver 2c is in a normal state, the CPU 2a outputs a transmission function stop request to the first transceiver 2c via the switch circuit 2b, and invalidates the transmission function of the first transceiver 2c (at S1). The CPU 2a starts measuring a predetermined time using a timer (at S2), and waits for the timer to complete measuring time (at S3). The predetermined time is the time interval required for disappearing the remaining transmission waveform on the Ethernet 6 caused by the signal transmission, and is variable.

When the CPU 2a determines that the timer has completed measuring time since the predetermined time has elapsed since the timer started measuring time (“YES” at S3), the CPU 2a outputs a forced sleep request to the first transceiver 2c via the switch circuit 2b, and causes the first transceiver 2c to perform the forced sleep process (at S4). The CPU 2a outputs a transmission function restart request to the first transceiver 2c via the switch circuit 2b, and validates the transmission function of the first transceiver 2c (at S5).

By performing the forced sleep process after a predetermined time has elapsed since invalidating the transmission function of the first transceiver 2c, the forced sleep process can be performed in a state where no transmission waveform caused by the reflection remains on the Ethernet. In this case, since the reception function of the first transceiver 2c remains validated, the wake-up request signal from the second ECU 3 can be received even during the period from when the transmission function is invalidated to when the transmission function is validated.

The above-described first embodiment provides following technical effects. In the first ECU 2, the forced sleep process is performed after a predetermined time has elapsed since the transmission function of the first transceiver 2c is invalidated. The forced sleep process can be performed in a state where no transmission waveform remains on the Ethernet 6 due to reflection. Thus, it is possible to prevent a situation in which a remaining signal due to a remaining transmission waveform is mistakenly detected as a wake-up signal and the state returns from a sleep state to a wake-up state, so that the forced sleep process can be performed properly.

### Second Embodiment

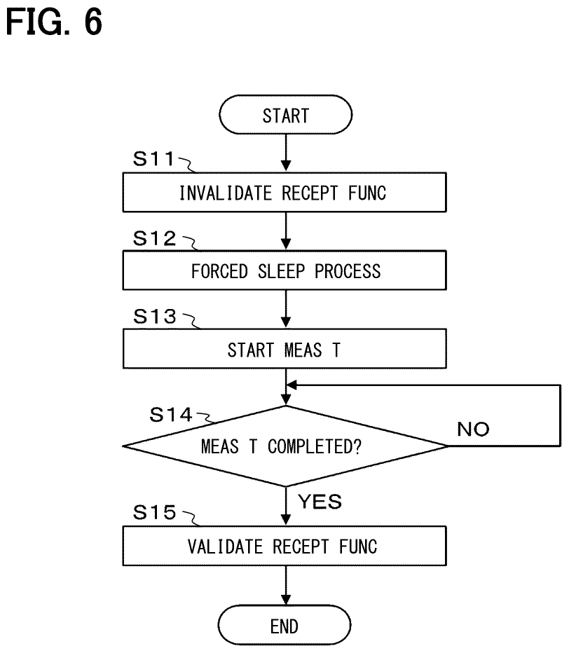

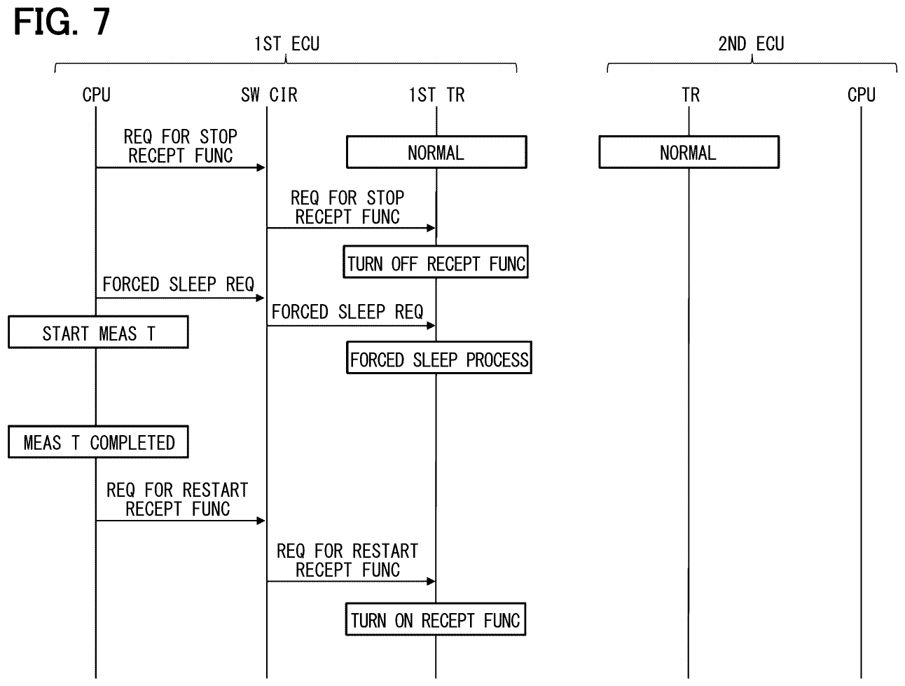

The following will describe a second embodiment with reference to FIGS. 6 to 7. The second embodiment is configured to invalidate the reception function of the first transceiver 2c and then cause the first transceiver 2c to perform the forced sleep process.

In the first ECU 2, when the first transceiver 2c is in a normal state, the CPU 2a outputs a reception function stop request to the first transceiver 2c via the switch circuit 2b, and invalidates the reception function of the first transceiver 2c (at S11). The CPU 2a outputs a forced sleep request to the first transceiver 2c via the switch circuit 2b, and causes the first transceiver 2c to execute the forced sleep process (at S12). The CPU 2a starts measuring time a predetermined time using a timer (at S13), and waits for the timer to complete measuring time (at S14). In this case, the predetermined time is the time interval required for disappearing the remaining transmission waveform on the Ethernet 6 caused by the signal transmission, and is variable.

When the CPU 2a determines that the timer has completed measuring time when a predetermined time has elapsed since the timer started measuring time (“YES” at S14), the CPU 2a outputs a request to restart the reception function to the first transceiver 2c via the switch circuit 2b, and validates the reception function of the first transceiver 2c (at S15).

In other words, by invalidating the reception function of the first transceiver 2c and performing the forced sleep process, even if the transmission waveform remains on the Ethernet 6 due to reflection, the forced sleep process can be performed in a state where the reception of the remained signal due to the remaining transmission waveform is invalidated. Here, in the above, a configuration has been described in which the reception function of the first transceiver 2c is validated after it has been determined that the timer has completed measuring time. Alternatively, if it is assumed that, for example, due to system reasons, the second ECU 3 may constantly transmit signals and it is not desired to be affected by this feature, then it is not necessary to validate the reception function of the first transceiver 2c, and the reception function of the first transceiver 2c may remain invalidated. In this case, it is not affected by the signal from the second ECU 3 during the period from when the reception function of the first transceiver 2c is invalidated to when the reception function of the first transceiver 2c is validated. Moreover, compared to the first embodiment, the forced sleep process can be executed at an earlier timing.

The above-described second embodiment provides following operational effects. In the first ECU 2, the reception function of the first transceiver 2c is invalidated before the forced sleep process is performed. Even if the transmission waveform remains on Ethernet 6 for a certain period of time due to reflection after signal transmission has stopped, the forced sleep process can be performed in a state where the reception of the remained signal due to the remaining transmission waveform is invalidated. Thus, it is possible to prevent a situation in which a remaining signal due to a remaining transmission waveform is mistakenly detected as a wake-up signal and the state returns from a sleep state to a wake-up state, so that the forced sleep process can be performed properly.

### Third Embodiment

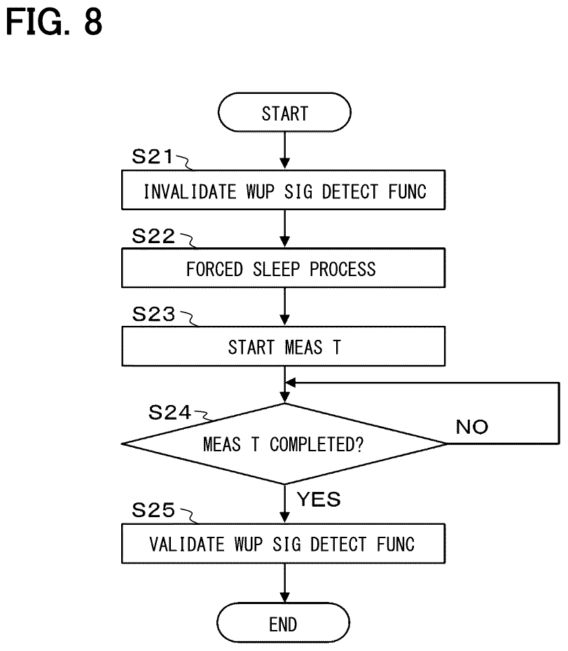

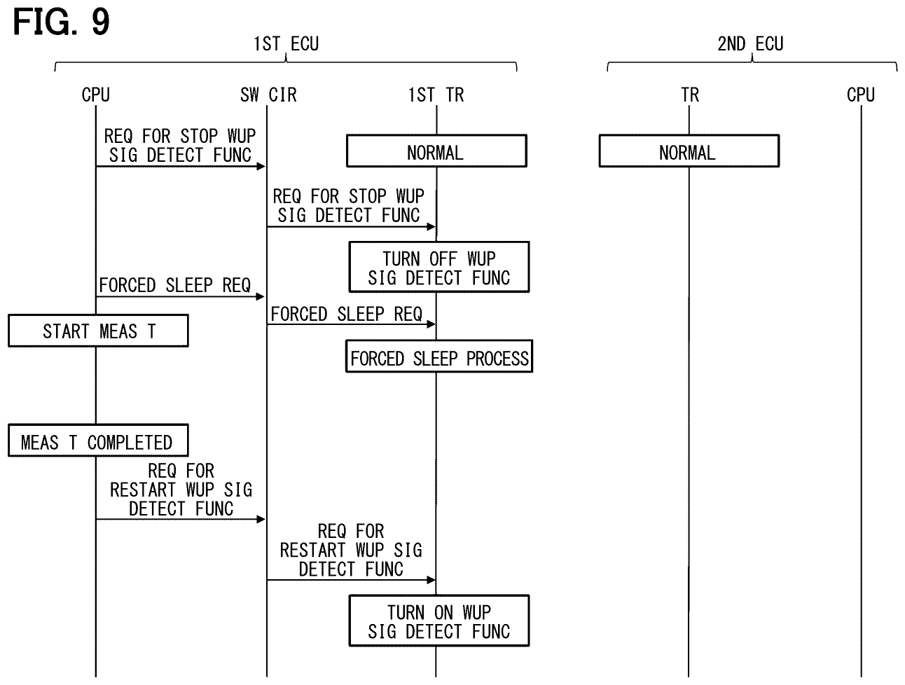

The following will describe a third embodiment with reference to FIGS. 8 to 9. The third embodiment is configured to invalidate the wake-up signal (i.e., WUP signal) detection function of the first transceiver 2c and then cause the first transceiver 2c to perform the forced sleep process.

In the first ECU 2, when the first transceiver 2c is in a normal state, the CPU 2a outputs a wake-up signal detection function stop request to the first transceiver 2c via the switch circuit 2b, and invalidates the wake-up signal detection function of the first transceiver 2c (at S21). The CPU 2a outputs a forced sleep request to the first transceiver 2c via the switch circuit 2b, and causes the first transceiver 2c to execute the forced sleep process (at S22). The CPU 2a starts measuring a predetermined time using a timer (at S23), and waits for the timer to complete measuring time (at S24).

When the CPU 2a determines that the timer has completed measuring time since a predetermined time has elapsed after the timer started measuring time (“YES” at S24), the CPU 2a outputs a request to restart the wake-up signal detection function to the first transceiver 2c via the switch circuit 2b, and validates the wake-up signal detection function of the first transceiver 2c (at S25).

In other words, by invalidating the wake-up signal detection function of the first transceiver 2c and performing the forced sleep process, even if the transmission waveform remains on the Ethernet 6 due to reflection and a remained signal due to that remaining transmission waveform is received, the forced sleep process can be performed in a state where the wake-up signal detection is invalidated. In this case, if it is assumed that the second ECU 3 may constantly transmit a signal due to system reasons, for example, and it is not desired to be affected by this feature, then it is not necessary to validate the wake-up signal detection function of the first transceiver 2c, and the wake-up signal detection function of the first transceiver 2c may remain invalidated. Moreover, in this case, compared to the first embodiment, the forced sleep process can be executed at an earlier timing.

The above-described third embodiment provides following operational effects. By performing the forced sleep process after invalidating the wake-up signal detection function of the first transceiver 2c, even if the transmission waveform remains on the Ethernet for a certain period of time due to reflection after signal transmission has been stopped, and the remaining signal caused by the remaining transmission waveform is received, the forced sleep process can be performed in a state where the detection of the wake-up signal is invalidated. Thus, it is possible to prevent a situation in which a remaining signal due to a remaining transmission waveform is mistakenly detected as a wake-up signal and the state returns from a sleep state to a wake-up state, so that the forced sleep process can be performed properly.

### Fourth Embodiment

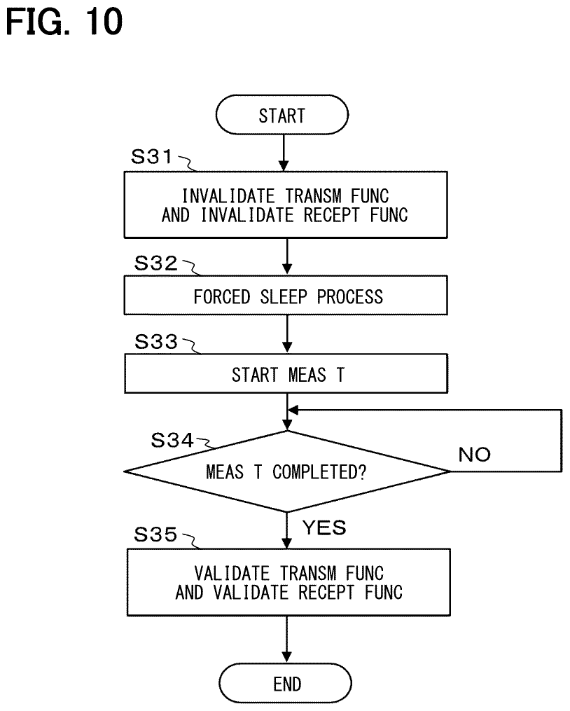

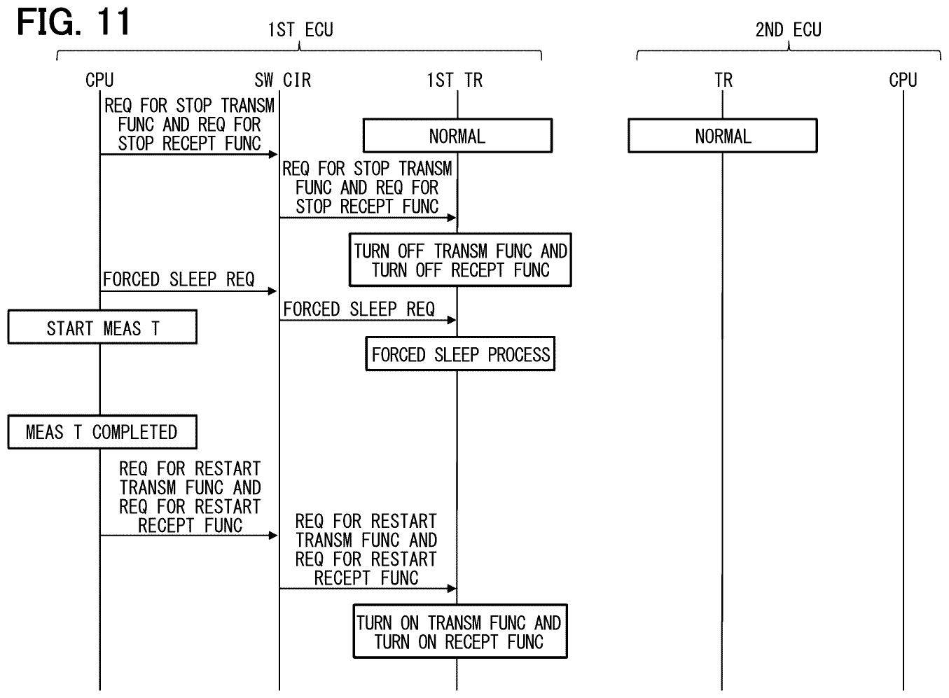

The following will describe a fourth embodiment with reference to FIGS. 10 to 11. The fourth embodiment is configured to invalidate the transmission function and the reception function of the first transceiver 2c and then cause the first transceiver 2c to perform the forced sleep process.

In the first ECU 2, when the first transceiver 2c is in a normal state, the CPU 2a outputs a transmission function stop request and a reception function stop request to the first transceiver 2c via the switch circuit 2b, and invalidates the transmission function and the reception function of the first transceiver 2c (at S31). The CPU 2a outputs a forced sleep request to the first transceiver 2c via the switch circuit 2b, and causes the first transceiver 2c to execute the forced sleep process (at S32). The CPU 2a starts measuring a predetermined time using a timer (at S33), and waits for the timer to complete measuring time (at S34).

When the CPU 2a determines that the timer has completed measuring time when a predetermined time has elapsed since the timer started measuring time (“YES” at S34), the CPU 2a outputs a request to restart the transmission function and a request to restart the reception function to the first transceiver 2c via the switch circuit 2b, and validates the transmission function and the reception function of the first transceiver 2c (at S35).

In other words, by invalidating the transmission function and the reception function of the first transceiver 2c and performing the forced sleep process, even if the transmission waveform remains on the Ethernet 6 due to reflection, the forced sleep process can be performed in a state where the reception of the remained signal due to the remaining transmission waveform is invalidated. Furthermore, for example, if it is assumed that the second ECU 3 may constantly transmit signals due to system reasons and it is not desired to be affected by this feature, it is not necessary to validate the reception function of the first transceiver 2c, and the transmission function of the first transceiver 2c may be validated and the reception function of the first transceiver 2c may remain invalidated. Moreover, in this case, compared to the first embodiment, the forced sleep process can be executed at an earlier timing. Although the configuration in which the transmission function and the reception function of the transceiver 2c are invalidated and then validated has been described above, the transmission function and the wake-up signal detection function of the transceiver 2c may be invalidated and then validated. Furthermore, the transmission function, the reception function and the wake-up signal detection function of the transceiver 2c may be invalidated and then validated.

The above-described fourth embodiment provides following operational effects. The forced sleep process is performed after the transmission function and the reception function of the first transceiver 2c are invalidated. Even if the transmission waveform remains on Ethernet 6 for a certain period of time due to reflection after signal transmission has stopped, the forced sleep process can be performed in a state where the reception of the remained signal due to the remaining transmission waveform is invalidated. Thus, it is possible to prevent a situation in which a remaining signal due to a remaining transmission waveform is mistakenly detected as a wake-up signal and the state returns from a sleep state to a wake-up state, so that the forced sleep process can be performed properly.

### Fifth Embodiment

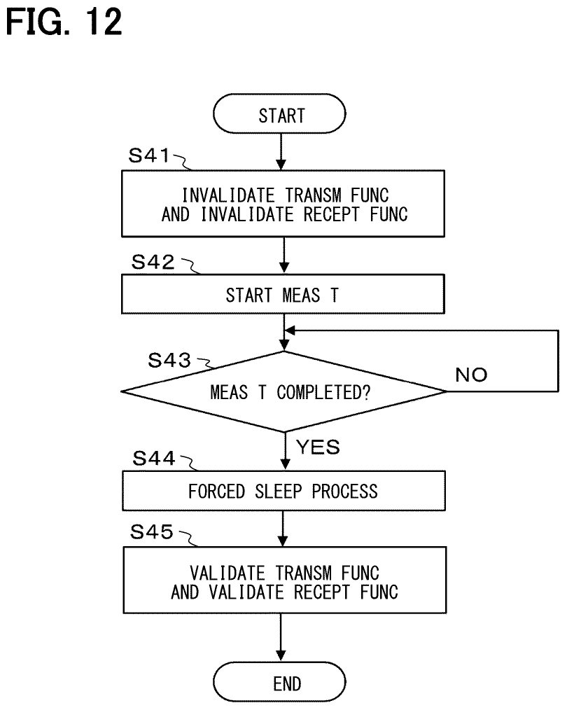

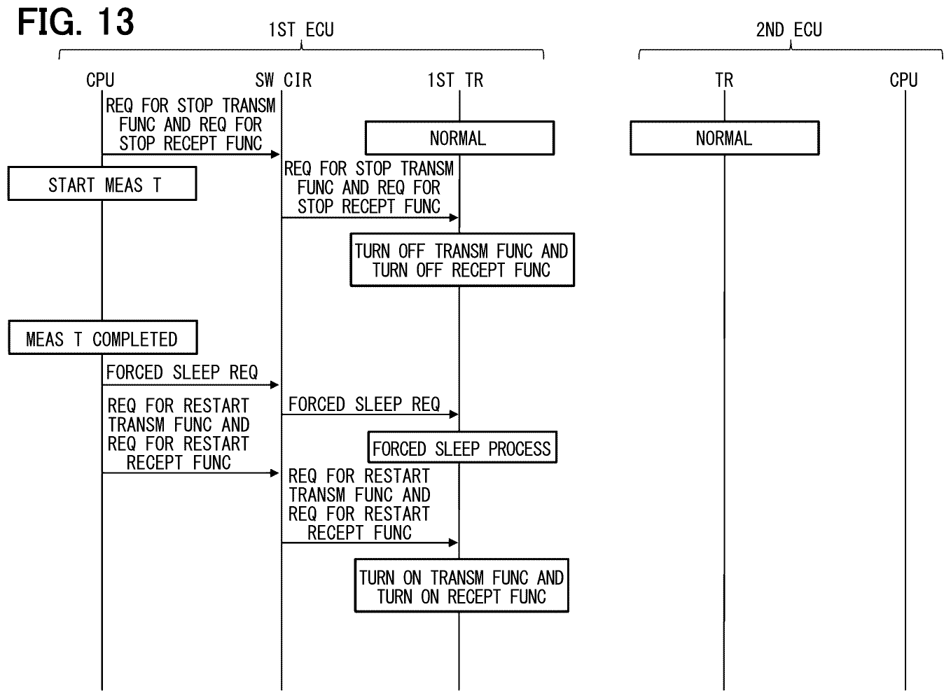

The following will describe a fifth embodiment with reference to FIGS. 12 to 13. The fifth embodiment is configured to cause the first transceiver 2c to perform the forced sleep process after a predetermined time has elapsed since the transmission function and the reception function of the first transceiver 2c are invalidated.

In the first ECU 2, when the first transceiver 2c is in a normal state, the CPU 2a outputs a transmission function stop request and a reception function stop request to the first transceiver 2c via the switch circuit 2b, and invalidates the transmission function and the reception function of the first transceiver 2c (at S41). The CPU 2a starts measuring a predetermined time using a timer (at S42), and waits for the timer to complete measuring time (at S43).

When the CPU 2a determines that the timer has completed measuring time since the predetermined time has elapsed since the timer started measuring time (“YES” at S43), the CPU 2a outputs a forced sleep request to the first transceiver 2c via the switch circuit 2b, and causes the first transceiver 2c to perform the forced sleep process (at S44). The CPU 2a outputs a transmission function restart request and a reception function restart request to the first transceiver 2c via the switch circuit 2b, and validates the transmission function and the reception function of the first transceiver 2c (at S45).

By performing the forced sleep process after a predetermined time has elapsed since invalidating the transmission function of the first transceiver 2c, the forced sleep process can be performed in a state where no transmission waveform caused by the reflection remains on the Ethernet. Furthermore, for example, if it is assumed that the second ECU 3 may constantly transmit signals due to system reasons and it is not desired to be affected by this feature, it is not necessary to validate the reception function of the first transceiver 2c, and the transmission function of the first transceiver 2c may be validated and the reception function of the first transceiver 2c may remain invalidated. In this case, although the configuration in which the transmission function and the reception function of the transceiver 2c are invalidated and then validated has been described above, the transmission function and the wake-up signal detection function of the transceiver 2c may be invalidated and then validated. Furthermore, the transmission function, the reception function and the wake-up signal detection function of the transceiver 2c may be invalidated and then validated.

The above-described fifth embodiment provides following operational effects. The forced sleep process is performed after a predetermined time has elapsed since the transmission and the reception functions of the first transceiver 2c are invalidated. The forced sleep process can be performed in a state where no transmission waveform remains on the Ethernet 6 due to reflection. Thus, it is possible to prevent a situation in which a remaining signal due to a remaining transmission waveform is mistakenly detected as a wake-up signal and the state returns from a sleep state to a wake-up state, so that the forced sleep process can be performed properly.

### Other Embodiments

In the data communication between the first ECU 2 and the second ECU 3, an example has been described in which the first ECU 2 operates as a master ECU and the second ECU 3 operates as a slave ECU, alternatively, the present embodiments can also be applied to a case in which the second ECU 3 operates as a master ECU and the first ECU 2 operates as a slave ECU. The present embodiments can also be applied to data communication between other ECUs.

Although the present disclosure has been described according to the embodiments, it is understood that the present disclosure is not limited to the above-described embodiments or structures. The present disclosure also includes various modification examples and modifications within an equivalent range. Additionally, various combinations and configurations, as well as other combinations and configurations including more, less, or only a single element, are within the scope and spirit of the present disclosure.

The controller and the method thereof described in the present disclosure may be implemented by a dedicated computer provided by configuring a processor and a memory programmed to execute one or more functions embodied by a computer program. Alternatively, the controller and the method thereof described in the present disclosure may be implemented by a dedicated computer provided by configuring a processor with one or more dedicated hardware logic circuits. Alternatively, the controller and the method described in the present disclosure may be implemented by one or more dedicated computers including the combination of a processor programmed to execute one or more functions and a memory and a processor including one or more hardware logic circuits. The computer program may be stored in a computer-readable non-transitory tangible storage medium as an instruction to be executed by the computer.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a data communication system to perform functions” should be understood that (i) only the circuit can cause the data communication system to perform all the functions, (ii) only the processor can cause the data communication system to perform all the functions, or (iii) the circuit can cause the data communication system R to perform at least one of the functions and the processor can cause the data communication system to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A data communication device connected to an Ethernet comprising:
a data transmission and reception unit in which at least one of a data transmission side and a data reception side conforms to a TC 10 specification, wherein:
the data transmission and reception unit executes a forced sleep process to force the data transmission and reception unit to be in a sleep state after a predetermined time has elapsed since invalidating a transmission function of the data transmission and reception unit; and the data transmission and reception unit validates the transmission function of the data transmission and reception unit after completing the forced sleep process.

2. The data communication device according to claim 1, wherein:
the predetermined time is a time required for disappearing a remaining transmission waveform on the Ethernet caused by signal transmission.

3. The data communication device according to claim 2, wherein:
the predetermined time is variable.

4. A data communication device connected to an Ethernet comprising:
a data transmission and reception unit in which at least one of a data transmission side and a data reception side conforms to a TC 10 specification, wherein:
the data transmission and reception unit executes a forced sleep process to force the data transmission and reception unit to be in a sleep state after invalidating a reception function of the data transmission and reception unit.

5. The data communication device according to claim 4, wherein:
the data transmission and reception unit validates the reception function of the data transmission and reception unit after a predetermined time has elapsed since completing the forced sleep process.

6. The data communication device according to claim 5, wherein:
the predetermined time is a time required for disappearing a remaining transmission waveform on the Ethernet caused by signal transmission.

7. The data communication device according to claim 6, wherein:
the predetermined time is variable.

8. A data communication device connected to an Ethernet comprising:
a data transmission and reception unit in which at least one of a data transmission side and a data reception side conforms to a TC 10 specification, wherein:
the data transmission and reception unit executes a forced sleep process to force the data transmission and reception unit to be in a sleep state after invalidating a wake-up signal detection function of the data transmission and reception unit.

9. The data communication device according to claim 8, wherein:
the data transmission and reception unit validates the wake-up signal detection function of the data transmission and reception unit after a predetermined time has elapsed since completing the forced sleep process.

10. The data communication device according to claim 9, wherein:
the predetermined time is a time required for disappearing a remaining transmission waveform on the Ethernet caused by signal transmission.

11. The data communication device according to claim 10, wherein:
the predetermined time is variable.

12. A data communication system comprising:
a data communication device connected to an Ethernet and having a transmission and reception unit in which at least one of a data transmission side and a data reception side conforms to a TC 10 specification, wherein:
the data communication device executes a forced sleep process to force the data transmission and reception unit to be in a sleep state after a predetermined time has elapsed since invalidating a transmission function of the data transmission and reception unit; and the data communication device validates the transmission function of the data transmission and reception unit after completing the forced sleep process.

13. The data communication system according to claim 12, wherein:
the predetermined time is a time required for disappearing a remaining transmission waveform on the Ethernet caused by signal transmission.

14. The data communication system according to claim 13, wherein:
the predetermined time is variable.

15. A data communication system comprising:
a data communication device connected to an Ethernet and having a transmission and reception unit in which at least one of a data transmission side and a data reception side conforms to a TC 10 specification, wherein:
the data communication device executes a forced sleep process to force the data transmission and reception unit to be in a sleep state after invalidating a reception function of the data transmission and reception unit.

16. The data communication system according to claim 15, wherein:
the data communication device validates the reception function of the data transmission and reception unit after a predetermined time has elapsed since completing the forced sleep process.

17. The data communication system according to claim 16, wherein:
the predetermined time is a time required for disappearing a remaining transmission waveform on the Ethernet caused by signal transmission.

18. The data communication system according to claim 17, wherein:
the predetermined time is variable.

19. A data communication system comprising:
a data communication device connected to an Ethernet and having a transmission and reception unit in which at least one of a data transmission side and a data reception side conforms to a TC 10 specification, wherein:
the data communication device executes a forced sleep process to force the data transmission and reception unit to be in a sleep state after invalidating a wake-up signal detection function of the data transmission and reception unit.

20. The data communication system according to claim 19, wherein:
the data communication device validates the wake-up signal detection function of the data transmission and reception unit after a predetermined time has elapsed since completing the forced sleep process.

21. The data communication system according to claim 20, wherein:
the predetermined time is a time required for disappearing a remaining transmission waveform on the Ethernet caused by signal transmission.

22. The data communication system according to claim 21, wherein:
the predetermined time is variable.
